(19) United States
(12) Patent Application Publication
(10) Pub. No.: US 2002/0076007 A1
(43) Pub. Date: Jun. 20, 2002

(54) Telephone system including voice mail screening

(76) Inventors: Elizabeth Goldwyn Gibson, Austin, TX (US); James Thomas Miller, Austin, TX (US); William Eisenloeffel, San Antonio, TX (US)

Correspondence Address: SAWYER LAW GROUP LLP, PO Box 51418, Palo Alto, CA, 94303, US

(21) Appl. No.: 09/741,244

(22) Filed: Dec. 19, 2000

(51) Int. Cl. H04M 1/64; H04M 3/42

(52) U.S. Cl. 379/67.1; 379/201.01; 379/207.01

(57) ABSTRACT

A telephone system which includes voice mail screening is disclosed. The telephone system includes a switching system for receiving a call from a calling party. The system also includes a voice mailbox which is coupled to the switching system if the called party does not answer the call. The system further includes a telephone for receiving the call from the calling party. The telephone is capable of screening the calling party when the calling party is coupled to the voice mailbox.

### FIELD OF THE INVENTION

The present invention relates generally to telephones and more particularly to a telephone that includes a voice mail screening system.

### BACKGROUND OF THE INVENTION

Telephone systems typically have voice mailbox 4 that are utilized therewith. FIG. 1 illustrates a conventional telephone system 10 which includes a voice mailbox 4. As is seen, a called party at telephone 7 which is connected to a central switch 3, via line 6, receives calls from the calling party at telephone 1 through the switch. A voice mailbox 4 is also attached to the switching system. The voice mailbox 4 receives calls from the calling party and then provides messages from the calling party at telephone 1 to the called party at telephone 7.

The called party at telephone 7 receives voice mails through the following process. The calling party at telephone 1 calls via the switching system 3 to the called party at telephone 7 and the called party at telephone 7 does not pick up the phone after a predetermined number of rings. Thereafter, the voice mail box 4 intercepts the call to the called party at telephone 7 and provides the outgoing voice mail message to the calling party at telephone 1. Then, at the appropriate time the calling party at telephone 1 leaves a message within the voice mailbox 4 to the called party at telephone 7. The called party at telephone 7 can then pick up the message from the calling party at telephone 1 via the voice mailbox 4. These types of systems are well known and will not be discussed in any detail further herein. However, one of the issues associated with such systems is that the called party at telephone 7 may be screening his/her calls and may not desire to pick up the phone for some calls and may desire to pick up the phone for other calls. Accordingly, it is then desired to be able to provide an ability to screen the voice mail as the calling party at telephone 1 is leaving a message.

The ability to screen the voice mails has been conventionally performed using adjunct boxes. Conventional adjunct boxes for voice mail screening are manufactured by Notify Technology Corp. and Solopoint, Inc. FIG. 2 is an illustration of a conventional telephone system 10′ that includes an adjunct box 11 for voice mail screening. The adjunct box 11 is connected directly to the switching system 3′, via line 9, and is also coupled to the telephone 7′, via line 15. This type of system would work in the following manner. The voice mail process is similar to that described in FIG. 1.

However, when the voice mailbox 4′ starts to play its message, the switching system 3′ provides an indication to the adjunct box 11 that voice mail is initiated. The adjunct box 11 will then through its speaker broadcast the calling party's message. The calling party at telephone 1′ through the telephone 7′ can then pick up the telephone 7′ if the calling party at telephone 1′ wants to answer the phone.

This connection between the switching system 3′ and the adjunct box 11 causes timing issues between the switching system 3′ and the voice mailbox 4′ and affects the reliability thereof. In addition, the adjunct boxes user interface is complex and difficult to use. What is desired therefore is a system for voice mail screening which is one-piece, simple, easy to use, and easily adaptable to existing telephone systems. The present invention addresses such a need.

### BRIEF DESCRIPTION OF THE DRAWINGS

FIG. 1 illustrates a conventional telephone system which includes a voice mail system.

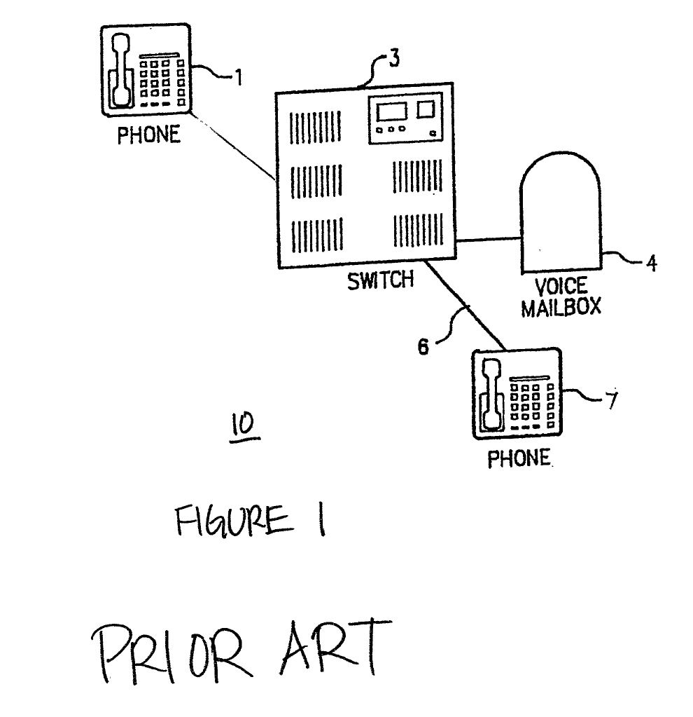

FIG. 2 is an illustration of a conventional telephone system that includes an adjunct box for voice mail screening.

FIG. 3 is an illustration of a voice mail screening system in accordance with the present invention.

FIG. 4 is a flow chart that illustrates the operation of the voice mail screening system in accordance with the present invention.

FIG. 5 is a front view of a preferred embodiment of the telephone which includes the voice mail screening option therewithin.

### DETAILED DESCRIPTION

The present invention relates generally to telephones and more particularly to a telephone that includes a voice mail screening system. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

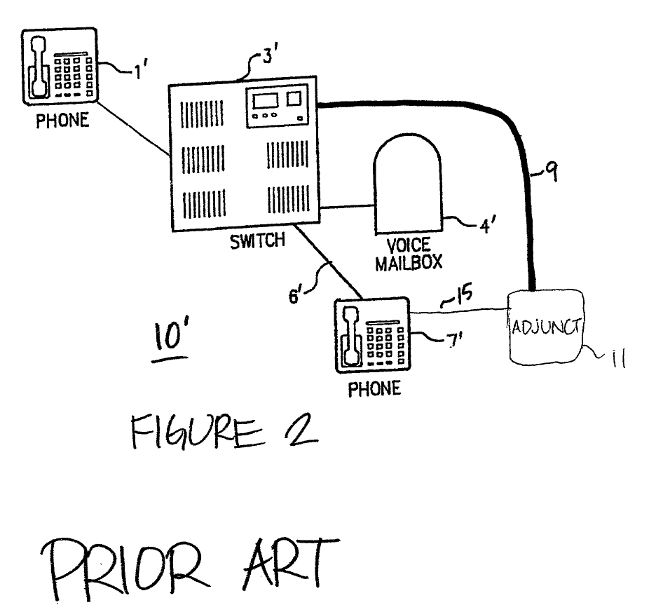

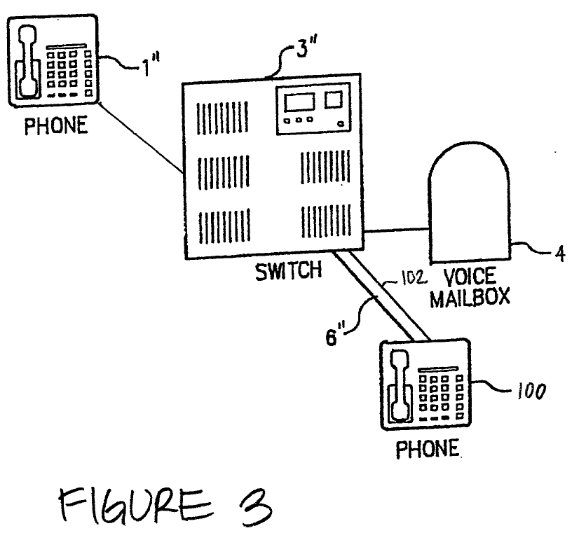

A voice mail screening system that is within a telephone is disclosed. FIG. 3 is an illustration of a voice mail screening system in accordance with the present invention. As is seen, the voice mail screening system in accordance with the present invention has similar elements to that described in FIG. 2. However, the adjunct box is not utilized. The telephone 100 allows the voice mail screening to take place. Further, the telephone 100 would include an algorithm therewithin for causing the telephone 100 to set up a three-way call to allow for the voice mail screening operation. The algorithm is preferably implemented using a software on a chip. One of ordinary skill in the art the algorithm could be implemented using a CD-ROM, floppy disk or other type of computer-readable medium and that use would be within the spirit and scope of the present invention.

To more fully describe the features of the present invention, refer now to the following description in conjunction with the accompanying figures.

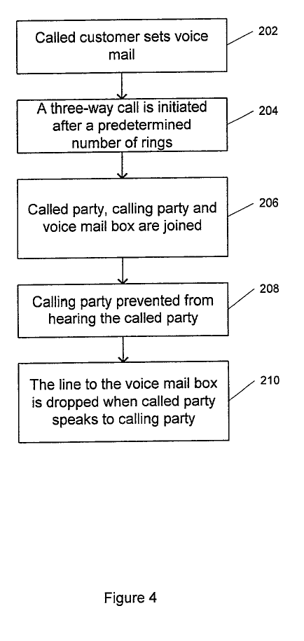

FIG. 4 is a flow chart which describes a voice mail screening system in accordance with the present invention. Referring to FIGS. 3 and 4 together, first, the called party at telephone 100 sets voice mail to pick up after a predetermined number of rings, in this case, two rings, via step 302. Next, the telephone 100 performs a flash-hook (i.e., goes off hook), which initiates three-way call through line 102 of the voice mailbox 4″, the called party at telephone 100 and the calling party at telephone 1″, via step 304. When the voice mailbox 4″ picks up again, the telephone joins the three parties (calling party at telephone 1″, voice mailbox 4″, and called party at telephone 100), via step 306.

When these lines are set up, voice mail is muted such that the calling party at telephone 1″ cannot hear the called party at telephone 100, although the called party at telephone 100 can hear the calling party at telephone 1″ and the voice mailbox 4″, via step 308. When the called party at telephone 100 picks up (i.e., if the called party at telephone 100 wants to connect with the calling party at telephone 1″), the telephone 100 drops the line 102 to the voice mailbox 4″, and the line 6 between the calling party at telephone 1″ and the called party at telephone 100 is the only active line, via step 310.

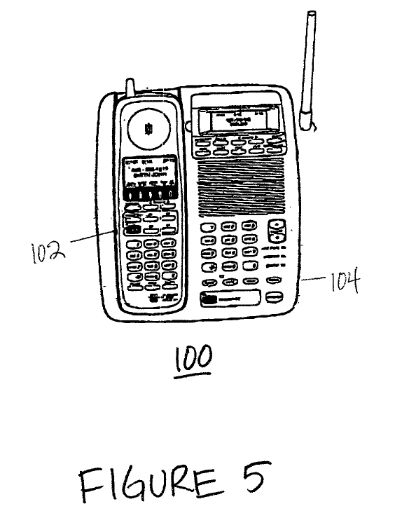

A user interface on the telephone 100 provides for access to the voice mail screening system. To illustrate the operation of the user interface, refer now to FIG. 5. FIG. 5 is a front view of a preferred embodiment of the telephone 100 which includes the voice mail screening option therewithin.

In the preferred embodiment in accordance with the present invention, the voice mail screening user interface is implemented in the following manner on the telephone 100. Voice mail screening is turned on or off by pressing, for example, a phone options key on the handset 102 or base 104 of the telephone 100. In this embodiment, the number “1” is pressed to turn the voice mail screening option ON and the number “2” is pressed to turn the voice mail screening option OFF.

After a selected number of rings (i.e. two rings), a caller will hear the message “Please hold while we complete your call.” Next, the caller will hear a voice mail prompt (outgoing message) asking the caller to leave a message. Thereafter, while the caller is leaving a message, the receiver of the call can take the call by pressing the TALK key (or a SPEAKERPHONE key on the base 104). If the receiver of the call does not want to take the call, then they take no action and the message will be left in the receiver's voice mailbox.

Accordingly, a voice mail screening system is provided in which the telephone of the called party is utilized to set up a three-way call between the voice mail box, the calling party and the called party. In so doing, the called party can listen to the calling party and if the called party desires, the called party can speak with the calling parties. The system and method in accordance with the present invention is one-piece, simple, easy to use, and easily implemented in existing telephone switching systems.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A telephone system comprising:
a switching system for receiving a call from a calling party;
a voice mail box coupled to the switching system for receiving the call if a called party does not answer the call; and
a telephone for receiving the call from the calling party, the telephone being capable of screening the calling party when the calling party is coupled to the voice mailbox.

2. The system of claim 1 wherein the telephone further includes first and second connections to the switching system, wherein in one of the first and second connections is utilized to provide a three-way call between the calling party, the called party and the voice mailbox.

3. The system of claim 2 wherein the three-way called party can not hear the calling party during the three-way call.

4. The system of claim 3 wherein the calling party can through interaction with the telephone talk with the calling party through the other of the first and second connections and the voice mail box is dropped from the call.

5. A method for voice mail screening comprising the steps of:
(a) receiving a call from a calling party by a voice mail box; and
(b) joining the called party, calling party and voice mailbox in a three-way call via a connection from a telephone of the called party such that the calling party can screen the calling party's message.

6. The method of claim 5 which includes the step of (c) preventing the calling party from hearing the called party, calling party and voice mailbox.

7. The method of claim 6 which includes the step of dropping the voice mail box from the three-way call by the telephone when the calling party speaks to the called party.

8. A computer readable medium containing program instructions for voice mail screening, the program instructions for:
(a) receiving a call from a calling party by a voice mail box; and
(b) joining the called party, calling party and voice mailbox in a three-way call via a connection from a telephone of the called party such that the calling party can screen the calling party's message.

9. The computer readable medium of claim 8 which includes the step of (c) preventing the calling party from hearing the called party, calling party and voice mail box.

10. The computer readable medium of claim 9 which includes the step of dropping the voice mail box from the three-way call by the telephone when the calling party speaks to the called party.

11. A telephone comprising:
a receiver for receiving a call from the calling party; and
a voice mail screening system within the telephone for allowing a called party of hearing the calling party when the calling party is coupled to a voice mailbox.

12. The telephone of claim 11 wherein the telephone further includes first and second connections to the switching system, wherein in one of the first and second connections is utilized to provide a three-way call between the calling party, the called party and the voice mailbox.

13. The telephone of claim 12 wherein the three-way called party can not hear the calling party during the three-way call.

14. The telephone of claim 13 wherein the calling party can through interaction with the telephone talk with the calling party through the other of the first and second connections and the voice mail box is dropped from the call.
